(19) United States
(12) Patent Application Publication
(10) Pub. No.: US 2023/0004794 A1
(43) Pub. Date: Jan. 5, 2023

(54) TRAINING A SENSING SYSTEM TO DETECT REAL-WORLD ENTITIES USING DIGITALLY STORED ENTITIES

(71) Applicant: Arm Limited, Cambridge (GB)

(72) Inventors: Irenéus Johannes de Jong, Cambridge (GB); Vasileios Laganakos, Saffron Walden (GB)

(21) Appl. No.: 17/465,569

(22) Filed: Sep. 2, 2021

(30) Foreign Application Priority Data
Jul. 1, 2021 (EP) 21386041.4

(51) Int. Cl. G06N 3/08; G06N 3/04

(52) U.S. Cl. CPC G06N 3/08; G06N 3/0454

(57) ABSTRACT

Disclosed subject matter relates generally to forming a set of training parameters applicable to detection of two or more entities between and/or among a distribution of entities from a plurality of digitally stored observations. One or more training parameters of the set of training parameters may be modified to define a translation, which is applicable to detection of real-world entities corresponding to the two or more entities in the distribution of the digitally stored observations, wherein the forming of the translation is to be based, at least in part, on a first process to generate the two or more entities in the distribution of digitally stored observations and a second process to discriminate between and/or among the generated two or more entities based, at least in part, on the modified one or more training parameters

### BACKGROUND

### Field

The present disclosure relates generally to recognition of features or entities which may be performed, for example, by a computing device.

### Information

In a computer-vision application, for example, a computer may attempt to detect or discriminate among particular features or entities present, for example, in an image captured by an imaging device. Computer vision applications may make possible various automated commercial, industrial, and consumer processes, such as computer-assisted manufacturing, computer-assisted surveillance, computer-assisted navigation, computer-assisted automobile driving, and a variety of other types of automatic and/or robotic processes. Such computer-assisted applications may bring about increases in manufacturing productivity, increases in the accuracy of industrial processes, increases in the quality of manufactured products, as well as reductions in costs associated with industrial and manufacturing processes. In an industrial and/or manufacturing setting, computer-vision applications may bring about increases in industrial safety by reducing or eliminating the need for human operators to work in potentially dangerous and safety-compromised environments. In a personal/consumer setting, computer-assisted automobile driving may enhance safety for drivers, passengers, pedestrians, and occupants of nearby vehicles.

Computer-assisted processes, which may include computer-vision techniques, as well as computer-assisted techniques operating in other sensory domains (e.g., audio, olfactory, etc.) may utilize a computer model, for example, to guide a computer-assisted process. Responsive to a computing device determining that sensory input signals from a real-world environment match or at least accord with those generated via a computer model, the computing device may signal that one or more particular real-world entities have been encountered. Accordingly, it may be appreciated that developing accurate computer models, and/or other types of representations utilized by a computing device, may be instrumental in assisting a computing device to detect, discriminate, and/or recognize real-world entities. Thus, developing and/or providing accurate computer models and/or representations of real-world entities continues to be an active area of investigation.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram showing operation of a sensing system during a training process for detecting real-world entities using digitally stored entities, according to an embodiment;

FIG. 2 is a flow diagram depicting an example process for training a sensing system to detect real-world entities using digitally stored entities, according to an embodiment;

FIGS. 3, 4A, and 4B are schematic diagrams showing use of a translation in a sensing system to detect various attributes of a real-world image, according to embodiments;

FIG. 5 is a flow diagram depicting an example process for training a sensing system to detect real-world entities using digitally stored entities, according to an embodiment; and

FIG. 6 is a schematic diagram illustrating an example computing environment, in accordance with embodiments.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Further, it is to be understood that other embodiments may be utilized. Also, embodiments have been provided of claimed subject matter and it is noted that, as such, those illustrative embodiments are inventive and/or unconventional; however, claimed subject matter is not limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides guidance regarding reasonable inferences to be drawn; however, likewise, “in this context” in general without further qualification refers to the context of the present patent application.

As previously alluded to, in a computer-vision application a computing device coupled to, for example, an imaging sensor (e.g., a camera) may operate to detect one or more features or entities present in a captured image. In some instances, a computing device may employ a discriminator, which may allow the computing device to differentiate between and/or among various features or entities present in a captured image. In other types of computer-assisted applications, such as computer-assisted voice-to-text applications, a computing device coupled to an audio device (e.g., a microphone) may operate to detect one or more phonemes, words, or phrases present in electrical signals representing an audio stream. In still other types of computer-assisted applications, such as computer-assisted airborne chemical detection devices and/or olfactory sensing devices, a computing device may detect presence of volatile, potentially harmful, airborne chemical agents. These computer-assisted applications, and a variety of other computer-assisted applications, may permit automation of numerous commercial and industrial processes, such as computer-assisted manufacturing, computer-assisted surveillance, computer-assisted navigation, and numerous other automatic and/or robotic processes. Computer-assisted applications may additionally bring about increases in industrial safety by reducing or eliminating the need for human operators to work in potentially dangerous and safety-compromised environments. In a personal/consumer setting, computer-assisted automobile navigation, which may include vehicle speed and breaking control, adherence to a planned and/or preprogrammed route, object avoidance, and so forth, may enhance safety for drivers, passengers, pedestrians, and occupants of nearby vehicles.

Computer-assisted applications, may rely, at least to some extent, on a stored model and/or other type of representation of a real-world entity, which may serve as a basis of comparison between and/or among the real-world entity and the stored model and/or representation. Accordingly, in a computer vision application, for example, the application may detect presence of a feature and/or an entity in a captured image by performing a comparison operation between and/or among a portion of an image and the stored model and/or representation. In another example, a computer-assisted voice-to-text application may detect presence of a particular word and/or phrase by comparing electrical signals representing a portion of an audio stream with a stored model and/or representation of the particular word and/or phrase. In another example, a computer-assisted airborne chemical detection device may determine presence of a chemical agent by comparing electrical signals from a chemical detector with a stored representation of electrical impulses representing presence of particular airborne chemicals and/or compounds. Numerous other computer-assisted applications are possible, in which real-world entities are detected via comparison with stored models and/or representations, and claimed subject matter is not limited in this respect.

However, in many instances, it may be difficult, costly, and/or time-consuming to develop accurate computer models and/or representations of real-world entities. For example, in a computer-vision application that attempts to discriminate between and/or among features and/or entities present in a captured visual observation, obtaining depth parameters may permit differentiation between and/or among entities located relatively near a camera lens versus entities located relatively far from the camera lens. Although depth-of-field parameters of a scene may be determined via the use of a ranging sensor, such as a light detection and ranging (LI DAR) sensor, obtaining such measurements may represent a time-consuming process involving numerous discrete range-sensing operations. In some instances, depth-of-field parameters of the scene may be determined only after conducting thousands of discrete LIDAR measurements at a corresponding number of separate locations of a scene. In other instances, such as those involving computer-assisted applications other than those relating to computer vision, development of a model and/or representation of an audio stream, a chemical profile, etc., may also involve performing a large number of discrete measurements in an audio, sonar, infrared, wireless signal strength, or other type of domain.

In another approach, a human operator may be utilized to supervise a process of developing an accurate model and/or other type of representation of a real-world entity. In such an approach, a human operator may be tasked with presenting an entity to, for example, a computer-vision sensor and, following such presentation, determine whether the computing device has accurately detected the entity. Dependent upon whether the computing device has accurately detected presence of a particular entity, the human operator may modify one or more detection parameters utilized by the computer to detect presence of the particular entity. However, it may be appreciated that such a process may represent a laborious and repetitive course of actions to develop an accurate computer model and/or other type of representation.

Thus, in accordance with particular embodiments, digitally stored entities, which in this context denote digitally-represented entities that include, but are not limited to digitally stored entities generated by a computing device or actual, real-world entities for which representations are stored in a digital domain. Digitally stored entities generated by a computing device may encompass visual entities, such as visual entities generated by way of a computer executing a set of instructions, audio entities generated by way of the computer executing a set of instructions, chemical and/or olfactory entities generated by way of the computer executing a set of instructions, or may include any other entity for which a representation may be stored within a memory of a computing device. A digitally stored entity may represent an image obtained from, gleaned from, and/or assembled from, for example, a logical location accessible via the Internet. Accordingly, in an example, a digitally stored entity, such as an image of an apple or an image of a traffic sign, may be gleaned and/or assembled from two or more available visual images and/or other types of representations available on the Internet. Alternatively, or in addition to, gleaning a digital image of an apple from available images and/or other representations, for example, a digitally stored entity may be augmented, such as distorted, re-colored, lightened, darkened, enlarged in size, reduced in size, fragmented, and/or modified in some other way, prior to presentation for review by the computing device. The computing device may, in turn, utilizing one or more parameters of a training function, indicate whether the digitally stored entity has been detected in a computer-generated observation. Responsive to the computing device accurately detecting the digitally stored entity in, for example, a computer-generated observation, parameters of the training function may remain unmodified. However, responsive to the computing device failing to detect and entity or failing to discriminate a between and/or among entities present in a computer-generated observation, one or more parameters of a training function may be modified.

In particular embodiments, training a sensing system to detect real-world entities using digitally stored entities may utilize a generative adversarial network (GAN) to perform unsupervised (e.g., autonomous and/or without user input) development and/or refinement of parameters of a training function. The one or more digitally stored entities may be evaluated and/or reviewed by a computing device without the benefit of obtaining an advanced indication of the generated one or more entities. Responsive to a computing device inaccurately identifying and/or failing to detect a generated digitally stored entity, one or more parameters of a training function utilized by a computing device may be modified. In response to modification of parameters of a training function, a GAN may present the same or a similar digitally stored entity for review by the computing device. Responsive to a computing device inaccurately identifying and/or failing to detect a generated digitally stored entity, one or more parameters of a training function utilized by a computing device may be further modified. Accordingly, at least in particular embodiments, a GAN may iteratively repeat a process of generation of an entity in a digital domain, followed by attempted detection, refinement of parameters of a training function, and generation of another entity in a digital domain. In particular nonlimiting embodiments, such an iterative process may be referred to as a cycle-GAN process.

As previously mentioned, a cycle-GAN process may involve thousands, millions, tens of millions, or an even greater number (virtually without limitation) of cycles involving generation of a first digitally stored entity, detection of the first digitally stored entity, parameter modification in response to such detection, followed by generation of a second digitally stored entity, detection of the second digitally stored entity, and so forth. In particular embodiments, a cycle-GAN process may proceed without user input (e.g., autonomously), which may represent an inexpensive approach toward training a sensing system to detect real-world entities utilizing computer-generated, computer-augmented, computer-assembled, or entities otherwise obtained via a computing device (e.g., computer-generated) entities.

In particular embodiments, responsive to a cycle-GAN process that yields relatively accurate detection and/or discrimination of entities formed in a digital domain, real-world entities may be evaluated in lieu of digitally stored entities. In many instances, responsive to the extensive refinement of parameters of a training function to detect entities in a digital domain, such as via a cycle-GAN process, the training function may be adapted to operate, instead, utilizing real-world entities. In particular embodiments, such as embodiments involve being commercially available robotic computer-assisted devices (e.g., robotic in-home vacuum cleaners) a cycle-GAN process, for example, may be occasionally or periodically performed. Thus, in some instances, responsive to a computerized robotic vacuum cleaner failing to recognize a real-world entity in a room of a particular residence, a cycle-GAN process can be invoked, which may operate to refine one or more parameters of a training function. Accordingly, such refinements in training may operate to focus and/or to restrict refinement of a training function to exclusive problematic areas. In another example, such as computer-assisted automobile control, a cycle-GAN process can be occasionally or periodically invoked, which may operate to refine one or more parameters of a training function specific to a driving environment of an individual user.

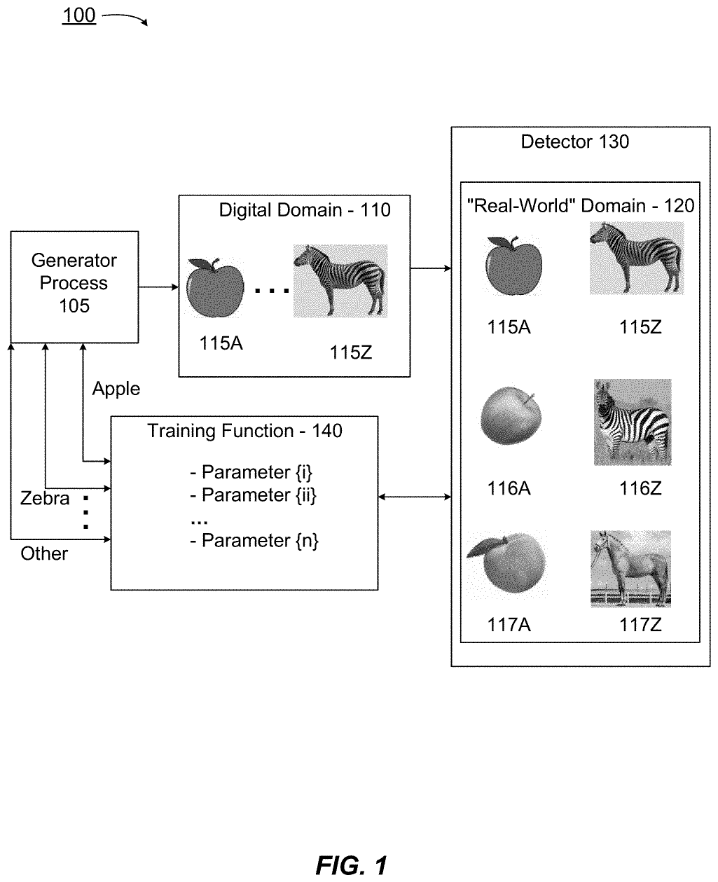

FIG. 1 is a schematic diagram showing operation of a sensing system during a training process for detecting real-world entities using digitally stored entities, according to an embodiment 100. In the embodiment of FIG. 1, generator process 105 may correspond to any process that operates to provide a source of computer-generated entities. Thus, generator process 105 may correspond to a computer gaming application, for example, in which digitally stored entities are generated to form images and/or scenes in a computer game. Generator process 105 may additionally correspond to a computer process in which stored captured images of actual (e.g. real-world) entities, such as apples, zebras, and/or a wide variety of other digitally stored entities, are augmented and/or modified utilizing a computer-based process. Accordingly, generator process 105 may be capable of generating, obtaining, and/or augmenting a wide variety of entities derived or gleaned from observations, such as observations that include fruits, vegetables, animals, vehicles, symbols, buildings, landscapes, etc., and claimed subject matter is not limited in this respect. Further, it may be appreciated that generator process 105 may be capable of generating, obtaining, and/or augmenting virtual entities other than those in the visual domain, such as observations that include audio entities (e.g., representations of sounds, phonemes, words, phrases, sentences etc.), observations that include radio signals, observations that include chemical/olfactory signals, or observations that include any other type of entity that can be sensed in a chemical, electromagnetic, auditory, or other type of domain, and claimed subject matter is not limited in this respect.

In the embodiment of FIG. 1, entities generated and/or obtained via generator process 105 may be conveyed and/or stored within digital domain 110. Digital domain 110 may correspond to any type of computer-generated and/or computer-augmented memory space capable of containing and/or facilitating formation of digitally storable entities. Accordingly, digital domain 110 may correspond to, for example, a two-dimensional memory array, within which observations that include representations of entities 115A-115Z may be virtually formed. Accordingly, entity 115A corresponds to a computer-generated apple, and entity 115Z corresponds to a computer-generated animal such as a zebra. It should be noted that digital domain 110 may include numerous other computer-generated, computer-assembled, computer-augmented, and/or computer-obtained entities, and claimed subject matter is not limited to any particular type or number of entities that may be formed and and/or conveyed to a digital domain. Additionally, entities stored within digital domain 110 may correspond to observations including entities other than predominantly visual entities, such as, for example, computer-generated and/or computer-augmented soundbites or other extracts from actual (e.g., real-world) sounds. Thus, observations including entities 115 stored within digital domain 110 may correspond to any type of computer-generated sounds, such as those generated by a human or by an animal. Additionally, in particular embodiments, observations that include entities stored within digital domain 110 may correspond to other computer-generated entities, such as, for example, observations that include a chemical profile of an airborne compound or of an ensemble of compounds, or may correspond to observations including any other computer-generated (virtual) entity, and claimed subject matter is not limited in this respect. Digital domain 110 may be coupled to a processor, a memory controller, and/or any number of other components of the computing device, which are not shown in FIG. 1 for the sake of simplicity.

In the embodiment of FIG. 1, generator process 105 may operate to form, or to facilitate the formation of, digitally stored entities, representations for which may be encountered in a real-world domain. Accordingly, as shown in FIG. 1, apple 115A may be conveyed to detector 130 to determine whether detector 130 is capable of returning a correct detection and/or classification of apple 115A and zebra 115Z. In addition to apple 115A, detector 130 may attempt to detect and/or classify additional digital entities from digital domain 110, such as apple 116A, zebra 116Z, etc. Accordingly, detector 130 may obtain and/or be exposed to a large number of digital entities from digital domain 110 as generated by generator process 105. In particular embodiments, generator process 105 may generate, augment, or otherwise obtain a large number of digitally storable entities, which may be conveyed via digital domain 110 for exposure to detector 130. Detector 130 may thus be “trained” for example by reviewing and/or observing perhaps hundreds, thousands, or millions (or more) of digitally stored entities generated, obtained, assembled, and/or augmented via generator process 105 that may correspond to actual, physical entities that may be encountered in “real-world” domain 120. Following placement of digital entities into “real-world” domain 120, detector 130 may attempt to detect, classify, and/or discriminate between and/or among other types of entities placed within “real-world” domain 120.

In this context, the terms “observe” and “observation” refer to a variety of sensing, measurement, or detection operations. Thus, for example, an imaging sensor may observe or may perform observations of one or more physical entities in a real-world visual scene. In another example, an audio sensor may observe or perform observations of audio signals present in an audio environment. In another example, a chemical or olfactory sensor may observe or perform observations to detect a presence of chemical or olfactory components in a gaseous environment. In another example, a wireless signal sensor may observe or perform observations of wireless signal strength, pulse width, modulation, frequency, or any other parameter of a wireless signal in an electromagnetic environment. Claimed subject matter is intended to embrace any and all sensing, measurement, and/or detection operations in real-world environments, virtually without limitation.

On occasion, detector 130 may fail to correctly identify a digitally stored entity within “real-world” domain 120. Although generator process 105 may form a digitally storable entity corresponding to apples, such as apple 115A and apple 116A, which may be correctly identified utilizing detector 130, detector 130 may, at least occasionally, incorrectly detect and/or incorrectly classify a digitally stored digital. As shown in FIG. 1, responsive to digital domain 110 conveying to “real-world” domain 120 a number of digital or virtual images corresponding to apples, detector 130 may, at least occasionally, erroneously and/or incorrectly detect a different fruit, such as peach 117A, for example. In another instance, responsive to digital domain 110 conveying to “real-world” domain 120 a number of images corresponding to zebras, detector 130 may occasionally incorrectly detect a different animal, such as horse 117Z.

As is also shown in FIG. 1, training function 140 may obtain output signals from detector 130 corresponding to, for example, apple 115A/116A, zebra 115Z/116Z. Thus, responsive to detector 130 correctly classifying and/or discriminating between and/or among received digitally stored entities, parameters of training function 140, such as parameter {i}, {ii}, . . . , {n}, may remain unchanged or unmodified. However, responsive to detector 130 incorrectly classifying and/or failing to discriminate between and/or among, for example, a peach and an apple, parameters of training function 140 (e.g., {i}, {ii}, . . . , {n}) may be changed, modified, and/or augmented. For example, in response to detector 130 incorrectly identifying an apple as peach 117A, color parameters of training function 140 (e.g., hue, saturation, and value) may be narrowed so as not to encompass color features corresponding to those of a peach. In another example, in response to detector 130 incorrectly identifying a zebra as horse 117Z, parameters of training function 140 may be modified, changed, and/or augmented.

In the embodiment of FIG. 1, modification of parameters of training function 140 may trigger generator process 105 to continue to generate digitally storable entities that test and/or challenge an ability for detector 130 to discriminate between and/or among digital entities. Accordingly, in particular embodiments, generator process 105 may generate, for example, digital entities, such as apples, that could mislead detector 130. By generating digital entities, such as an apple that could appear similar, for example, to a peach, training parameters employed by detector 130 may be tuned and/or updated. In particular embodiments, generator process 105 may be programmed, via computer-readable instructions, so as to generate a large number of, for example, apples that could be mistakenly classified and/or categorized by detector 130 as peaches, pears, or other entities that may appear to be visually similar to an apple.

Thus, dependent upon output signals from detector 130, and whether such output signals accurately correspond to a digitally stored entity generated by generator process 105, process 105 may be prompted to generate a disproportionately larger number of digital entities that can be utilized to fine-tune parameters of training function 140. In addition, for “real-world” digital entities correctly detected and/or discriminated by detector 130, generator process 105 may generate a disproportionately smaller number of digital entities. Hence, the training process for detecting real-world entities using digitally stored entities described in reference to FIG. 1 may involve a cyclical process in which a generator process (e.g., 105) repetitively and/or iteratively generates digitally storable entities that operate to fine tune parameters of training function 140. By doing so, generator process 105 may operate to focus development of parameters {i}, {ii}, . . . , {n} in a manner that enhances an ability of detector 130 to discriminate along boundaries of features that separate a first digital, such as an apple and a peach, a zebra and a horse, from a second digital. Thus, parameters of training function 140 may be enhanced so as to more easily (e.g., with greater probability) and successfully discriminate between and/or among entities, such as digitally storable entities, which may correspond to entities encountered in a real-world environment. In particular embodiments, training function 140 (utilizing parameters {i}, {ii}, . . . , {n}) may represent models and/or other types of representations of a variety of entities, which may number into the hundreds, thousands, millions, etc., which may be detected by detector 130.

In particular embodiments, detector 130 may correspond to a computing device, such as a neural network, that functions to detect and/or classify digitally stored entities presented to the computing device. In particular embodiments, detector 130 may correspond to a neural network comprising, a network of “neurons,” that function to generate output signals that indicate of detection of, for example, an apple, such as apple 120A. A neural network may comprise, for example, dozens, hundreds, thousands, or a greater number of neurons, which may produce and/or generate one or more output signal samples as a function of one or more input signal samples, for example. Thus, a neuron of a neural network, in an embodiment, may generate an output signal sample, such as f(x), responsive to one or more input signal samples, such as f(z1), f(z2), f(z3), and so forth. In particular embodiments, neurons of a neural network may generate, for example, an output signal responsive to executing a weighted superposition (e.g., summing) operation utilizing input signal samples f(z1), f(z2), and f(z3), such as shown in expression (1) below:

f(x)=w1f(z1)+w2f(z2)+w3f(z3) (1)

In expression (1), weights w1, w2, and w3, may comprise, for example, a value level in the range of approximately 0.0 to approximately 1.0. It should be pointed out that claimed subject matter is not restricted to use of a neural network utilizing weighted superposition of input signal samples. Rather, claimed subject matter is intended to embrace any machine- or computer-implemented process for categorizing, classifying, and/or discriminating between and/or among digitally stored entities placed or uploaded into “real-world” domain 120.

In particular embodiments, the overall scheme of FIG. 1 may operate in accordance with a cycle-GAN process in which, as previously described herein, generator process 105 iteratively and/or repetitively generates digitally storable entities that may correspond to real-world entities. Responsive to obtaining a digital entity from generator process 105, detector 130 may provide output signals corresponding to detection of the digitally stored entity. Responsive to detector 130 correctly detecting a generated digitally stored entity, parameters of training function 140 may be unamended/unmodified. However, responsive to detector 130 incorrectly detecting a generated digitally stored entity, parameters of training function 140 may be tuned and/or adjusted. Such tuning and/or adjustment may be utilized by detector 130 to evaluate subsequent digitally stored entities generated via generator process 105. Such a process of digitally storable entity generation, digital entity detection, and training function parameter update may be repeated in an autonomous and unsupervised manner (e.g., without human input) utilizing a neural network. In addition, responsive to synthesis of digitally storable entities, a variety of parameters, such as the number of digitally stored entities, colors of digitally stored entities, positioning of one or more digitally stored entities between and/or among one or more other digitally stored entities in a scene or image, as well as numerous other attributes, can be controlled and utilized as a basis upon which to compare output signals from a detector, such as detector 130 of FIG. 1.

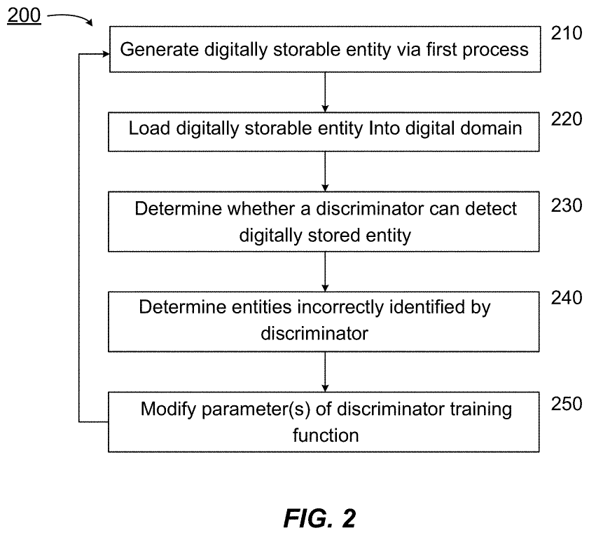

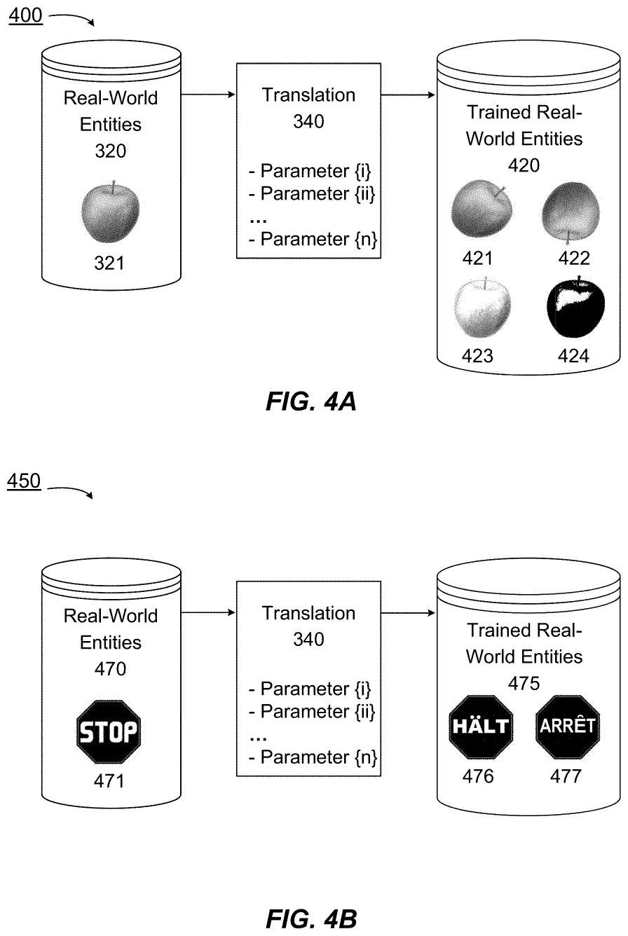

FIG. 2 is a flow diagram depicting an example process 200 for training a sensing system to detect real-world entities using digitally stored entities, according to an embodiment. The sensing system of FIG. 1 may be utilized to perform process 200 of FIG. 2, although alternative arrangements may also be utilized. It should be noted that disclosed embodiments, such as the embodiments of FIGS. 2 and 4, are intended to embrace numerous variations, including methods that may include actions in addition to those depicted in the figures, actions performed in an order different than those depicted in the figures, as well as methods including fewer steps than those depicted. Process 200 of FIG. 2 begins at block 210, in which digitally storable entities, such as digitized visual entities, digitized audio entities, digitized entities represented by radio signals, digital entities represented by chemical and/or olfactory signals, etc., may be generated by a generator process. Entities, such as digitally storable entities, generated at block 210 may correspond to any type of computer-generated entities, computer-augmented entities, computer-assembled entities, and/or virtual entities obtained from sources located throughout a computer network, such as the Internet. Claimed subject matter is intended to embrace all such computer-generated, computer-augmented, and other types of digitally stored entities capable of being uploaded to a digital domain, such as digital domain 110 of FIG. 1, and being evaluated by a detector, such as detector 130 also of FIG. 1.

At block 220, following generating, augmenting, or otherwise obtaining a digitally stored entity, the entity may be loaded into a digital domain. A digital domain of block 220 may correspond to, for example, a memory array, such as a two-dimensional memory array accessible to one or more computer processors. At block 230, the digitally stored entity may be conveyed to a detector, which may operate to detect a presence of the digitally stored entity in, for example, a scene. Block 230 may, alternatively, or in addition, involve discrimination of a digital entity within a computer-generated observation comprising numerous digitally stored entities. At block 240, a computer process may determine whether the detected digitally stored entity corresponds to a generated digital entity, such as an entity generated at block 210.

At block 250, parameters of a training function may be updated and/or modified based, at least in part, on incorrect detection of a digitally stored entity. In one possible example, responsive to a detector incorrectly identifying and/or classifying a digitally stored entity, color parameters of a training function may be modified and/or updated to include color parameters that more accurately characterize color features of a certain digitally stored entities. Other parameters of a training function may be modified and/or updated based, at least in part, on output signals generated by a detector, and claimed subject matter is not limited in this respect.

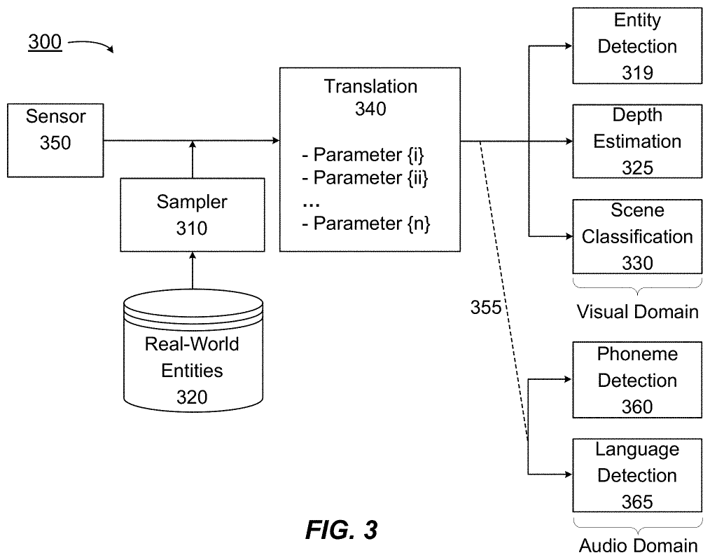

FIGS. 3, 4A, and 4B are schematic diagrams showing use of a translation in a sensing system to detect various attributes of a real-world image, according to embodiments. Embodiment 300 of FIG. 3 may be utilized to perform detection of real-world entities in a scene or other type of observation of a visual environment, estimation of the depth of a real-world entity in a scene or other type of observation of a visual environment, classification of a scene or other type of visual observation, and/or detection of other features of entities in a scene or other type of visual observation. As shown in FIG. 3, embodiment 300 may utilize translation 340, which may correspond to training function 140 previously discussed in reference to FIG. 1. Translation 340 of FIG. 3 may differ from training function 140 in that translation 340 comprises a version of training function 140 that has been sufficiently trained, such as via an iterative unsupervised process of digitally stored entity generation, digital entity detection, and training parameter update as described in reference to FIGS. 1 and 2. Accordingly, translation 340 may represent a version of training function 140 that has fully (or at least sufficiently) completed a training process.

Sensor 350 of FIG. 3 may correspond to any sensor capable of obtaining an observation of a real-world entity. Accordingly, sensor 350 may correspond to a camera or other type of image capture device. Thus, sensor 350 may operate to obtain one or more observations of any type of real-world entity and, utilizing translation 340, apply one or more parameters to the captured real-world entity so as to allow the real-world entity to undergo entity detection 319, depth estimation 325, and/or scene classification 330. In the embodiment of FIG. 3, entity detection may correspond to operations performed by detector 130 of FIG. 1. Depth estimation 325 may involve determination of a distance from a sensing element, such as a camera lens, and so forth. Scene classification 330 may correspond to a process in which scenes from photographs are categorically classified, such as pertaining to people, sporting events, ceremonies, parades, natural settings, and so forth.

Alternatively, sensor 350 may correspond to an audio sensor, such as a microphone, which may operate to obtain an observation of audio signals present in an audio environment, such as one or more sounds, one or more phonemes, one or more words, one or more phrases, one or more sentences, etc. Thus, as shown by dotted line 355, translation 340 may allow phoneme detection 360 (e.g., detection of a constituent portion of a word or phrase) and language detection 360 (e.g., detection of the English language with respect to any other spoken language). In addition, although not explicitly indicated in FIG. 3, sensor 350 may allow detection in a chemical and/or olfactory domain (e.g., airborne pollutants), which may operate to observe or ascertain a level of chemical compounds present in, for example, ambient air. Alternatively, sensor 350 may correspond to a wireless signal strength sensor, which may operate to observe measurements of strength, frequency, modulation, pulse width, or any other characteristic of a wireless signal at various locations inside or outside of a building, for example. Sensor 350 may correspond to any other sensing device, which may operate to utilize translation 340 to perform real-world entity detection, and claimed subject matter is not limited in this respect.

Sampler 310 may operate to customize and/or adapt a translation to a particular distribution of entities whose presence may be encountered and/or sensed by sensor 350. Thus, although a translation may correspond to a fully or sufficiently trained function, it is possible that parameters {i}, {II}, . . . {n} may benefit from being tailored to a particular environment. In one possible example, performance of an automatic housecleaning device, such as a household robotic vacuum cleaner, may be enhanced via additional training to adapt and/or customize parameters of a particular household environment. Continuing with such an example, responsive to a translation of an automated housecleaning device being trained utilizing an office environment (as opposed to a domestic household environment), which may comprise a substantial percentage of desks and office chairs, the robotic device may benefit from additional training in a domestic household environment. Accordingly, as an automated housecleaning device moves from room to room in the household environment, in which the device senses household entities such as furniture, sofas, bare and carpeted floors, etc., sampler 310 may determine a distribution of certain types of entities in relation to other types of entities. Thus, responsive to such sampling, sampler 310 may determine that additional training and/or optimization of parameters {i}, {II}, . . . {n} is warranted. Such additional training may enhance detection and discrimination between and/or among entities encountered by the automated housecleaning device.

In another example, described here and in reference to FIG. 4B, sampler 310 may operate to customize and/or adapt a translation to a particular distribution of real-world entities encountered while navigating an automobile in differing environments. For example, although a translation may correspond to a sufficiently or fully trained function, it is possible that parameters {i}, {ii}, . . . {n} may benefit from being tailored to a particular driving environments encountered from place to place. Thus, a computer-assisted automobile navigation system, which may operate to recognize particular real-world entities encountered while driving, may be enhanced via additional training to adapt and/or customize parameters of a particular driving environment. Thus, in an example, responsive to a translation of a computer-assisted automobile navigation system being initially trained in an urban environment, wherein a presence of a large number of (human) pedestrians may be encountered, the computer-assisted system may benefit from additional training to operate safely in a rural/desert environment. Accordingly, as an automobile is piloted through rural environments, in which sensor 350 senses a presence of certain wildlife, sampler 310 may determine a distribution of specific types of animals in relation to other types of animals. Thus, responsive to such detections, sampler 310 may determine that additional training and/or optimization of parameters {i}, {II}, . . . {n} is warranted. Such additional training may enhance detection and/or discrimination between and/or among particular types of animals that come into view of sensor 350 of the computer-assisted automobile navigation system responsive to operation in a rural environment.

In response to sampler 310 detecting a distribution of sensed real-world entities, sampler 310 may operate to query real-world entities database 320. In the embodiment of FIG. 3, real-world entities database 320 corresponds to captured real-world images and/or computer-generated images from a digital domain. Thus, real-world entities 320 may operate to enhance training and/or bring about further training of a translation. For example, in an application corresponding to an automated housecleaning device, sampler 310 may bring forth (e.g., upload) additional images corresponding to a domestic household environment. Such additional imagery may correspond to captured images of encountered entities, such as images of furniture, sofas, bare floors, and so forth. As mentioned previously, such additional real-world entities may operate to adapt a translation to a particular distribution of images, which may increase the probability of detection of a real-world entity in a visual scene, for example, entity feature detection (such as depth of certain features of an entity versus depth of other features of an entity present in a scene), and/or scene classification, among detection of other features.

FIG. 4A is a schematic diagram showing use of a translation in a sensing system to detect various attributes of a real-world image, according to an embodiment 400. In FIG. 4A, real-world entities database 320 may comprise numerous computer-generated, computer-augmented, and/or images obtained from various locations throughout the Internet, for example. Thus, a possible example of a real-world entity is apple 321. It may be appreciated that apple 321 may encompass a particular number of features, such as picture elements (pixels), as well as comprising particular values of orientation, hue, saturation, and value, as well as numerous other attributes. Translation 340 may comprise parameters, such as parameters {i}, {II}, . . . {n} shown in FIG. 3, which may operate to adapt such parameters to correspond to real-world apples stored in trained real-world entities database 420. Accordingly, trained real-world entities database 420 may include apple 321 oriented at a particular non-zero angle, as depicted as apple 421. Trained real-world entities database 420 may additionally include apple 321 oriented upside down (422), lightened (423) and/or significantly darkened (424). Accordingly, a single instance of apple 321 may be expanded, such as by way of parameters {i}, {ii}, . . . {n} of translation 340, to encompass a wide variety of possible real-world instances that correspond to apple 321.

FIG. 4B is a schematic diagram showing use of translation in a sensing system to detect various attributes of a real-world image, according to an embodiment 450. In FIG. 4B, real-world entities database 470 may comprise numerous computer-generated, computer-augmented, and/or images representative of actual (e.g., real-world) street and/or traffic signs obtained from various locations throughout the Internet and/or throughout one or more countries. In a possible example in which a representation of an actual (e.g., real-world) entity, such as stop sign 471, may map into a distribution of real-world entities (e.g., halt sign 476 and arrêt sign 477), it may be appreciated that stop sign 471 represents a traffic sign in Western countries, such as the United States. In such an instance, parameters {i}, {ii}, . . . {n}, which may relate to visual features of stop sign 471 may be adapted so as to permit detection of actual (e.g., real-world) traffic and/or street signs encountered in, for example, European countries. In a particular embodiment, parameters of translation 340 may be modified so as to be capable of detection of halt sign 476 and arrêt sign 477. Thus, as shown in FIG. 4B, translation 340 operates to translate between two or more actual (e.g., real-world) domains, such as a first domain comprising actual characters, words, and/or phrases of a first language, into a second domain, comprising characters, words, and/or phrases of a second language.

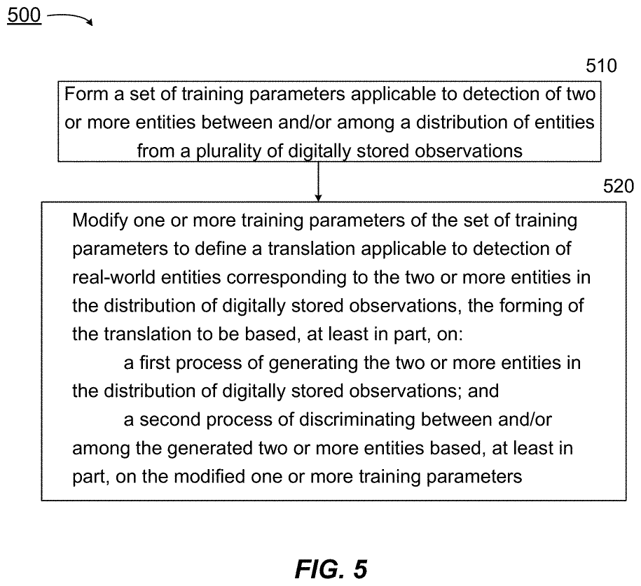

FIG. 5 is a flow diagram depicting an example process 500 for training a sensing system to detect real-world entities using digitally stored entities, according to an embodiment. The apparatus of FIGS. 3 and 4 may be suitable for performing the process of FIG. 5, although the process of FIG. 5 may be performed by alternative arrangements and/or structures. The process of FIG. 5 may begin at block 510, in which a set of training parameters may be formed. The training parameters may be applicable to detection of two or more entities between and/or among a distribution of entities from a plurality of digitally stored observations. The method may continue at block 520, which may include modifying one or more training parameters of the set of training parameters to define a translation applicable to detection of real-world entities corresponding to the one or more entities in the distribution of digitally stored observations. The forming of the translation may be based, at least in part, on a first process of generating the two or more entities, in the distribution of entities in the distribution of digitally stored observations. The forming of the translation may additionally be based, at least in part, on a second process of discriminating between and/or among the generated two or more entities based, at least in part, on the modified one or more training parameters.

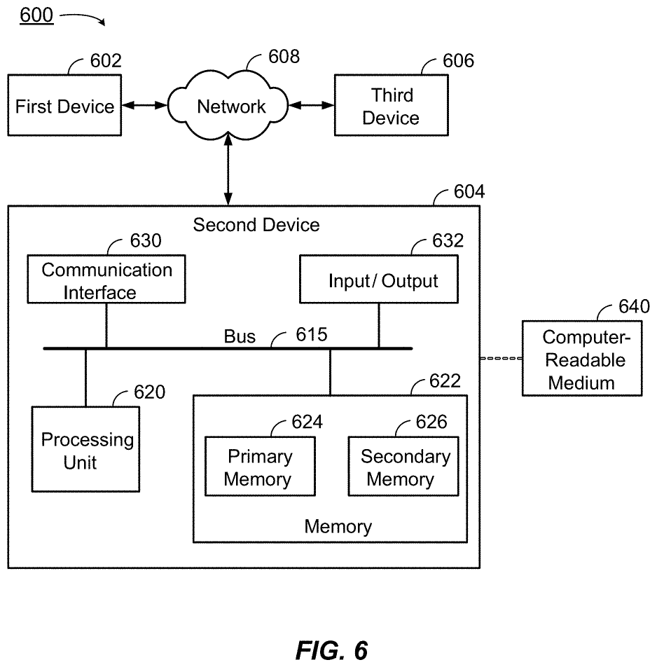

In one example embodiment, as shown in FIG. 6, a system embodiment may comprise a local network (e.g., device 604 and medium 640) and/or another type of network, such as a computing and/or communications network. For purposes of illustration, therefore, FIG. 6 shows an embodiment 600 of a system that may be employed to implement either type or both types of networks. Network 608 may comprise one or more network connections, links, processes, services, applications, and/or resources to facilitate and/or support communications, such as an exchange of communication signals, for example, between and/or among a computing device, such as 602, and another computing device, such as 606, which may, for example, comprise one or more client computing devices and/or one or more server computing device. By way of example, but not limitation, network 608 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 6 may comprise features, for example, of a client computing device and/or a remote/server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 112(f) so that it is specifically intended that 35 USC § 112(f) not be implicated by use of the term “computing device,” “processor” and/or similar terms; however, if it is determined, for some reason not immediately apparent, that the foregoing understanding cannot stand and that 35 USC § 112(f), therefore, necessarily is implicated by the use of the term “computing device,” “processor” and/or similar terms, then, it is intended, pursuant to that statutory section, that corresponding structure, material and/or acts for performing one or more functions be understood and be interpreted to be described at least in FIGS. 1-5 and in the text associated with the foregoing figure(s) of the present patent application.

Referring now to FIG. 6, in an embodiment, first and third devices 602 and 606 may be capable of rendering a graphical user interface (GUI) for a network device and/or a computing device, for example, so that a user-operator may engage in system use. Device 604 may potentially serve a similar function in this illustration. Likewise, in FIG. 6, computing device 602 (‘first device’ in figure) may interface with computing device 604 (‘second device’ in FIG. 6) via a communication interface 630. Computing device 604 may, for example, comprise features of a client computing device and/or a remote and/or server computing device, in an embodiment. Processor (e.g., processing device) 620 and memory 622, which may comprise primary memory 624 and secondary memory 626, may communicate by way of a communication bus 615, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 604, as depicted in FIG. 6, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 6, computing device 602 may provide one or more sources of executable computer instructions in the form physical states and/or signals (e.g., stored in memory states), for example. Computing device 602 may communicate with computing device 604 by way of a network connection, such as via network 608, for example. As previously mentioned, a connection, while physical, may not necessarily be tangible. Although computing device 604 of FIG. 6 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 622 may comprise any non-transitory storage medium. Memory 622 may comprise, for example, primary memory 624 and secondary memory 626, additional memory circuits, media, or combinations thereof may be used. Memory 622 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 622 may be utilized to store a program of executable computer instructions. For example, processor 620 may fetch executable instructions from memory and proceed to execute the fetched instructions. Memory 622 may also comprise a memory controller for accessing device readable-medium 640 that may carry and/or make accessible digital content, which may include code, and/or instructions, for example, executable by processor 620 and/or some other device, such as a controller, as one example, capable of executing computer instructions, for example. Under direction of processor 620, a non-transitory memory, such as memory cells storing physical states (e.g., memory states), comprising, for example, a program of executable computer instructions, may be executed by processor 620 and able to generate signals to be communicated via a network, for example, as previously described. Generated signals may also be stored in memory, also previously suggested.

Memory 622 may store electronic files and/or electronic documents, such as relating to one or more users, and may also comprise a computer-readable medium that may carry and/or make accessible content, including code and/or instructions, for example, executable by processor 620 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 6, processor 620 may comprise one or more circuits, such as digital circuits, to perform at least a portion of a computing procedure and/or process. By way of example, but not limitation, processor 620 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 604 as including a component 632 operable with input/output devices, for example, so that signals and/or states may be appropriately communicated between and/or among devices, such as device 604 and an input device and/or device 604 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between and/or among two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between and/or among one or more clients and one or more servers over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if a feature, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If, alternatively, reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall within the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

A “signal measurement” and/or a “signal measurement vector” may be referred to respectively as a “random measurement” and/or a “random vector,” such that the term “random” may be understood in context with respect to the fields of probability, random variables and/or stochastic processes. A random vector may be generated by having measurement signal components comprising one or more random variables. Random variables may comprise signal value measurements, which may, for example, be specified in a space of outcomes. Thus, in some contexts, a probability (e.g., likelihood) may be assigned to outcomes, as often may be used in connection with approaches employing probability and/or statistics. In other contexts, a random variable may be substantially in accordance with a measurement comprising a deterministic measurement value or, perhaps, an average measurement component plus random variation about a measurement average. The terms “measurement vector,” “random vector,” and/or “vector” are used throughout this document interchangeably. In an embodiment, a random vector, or portion thereof, comprising one or more measurement vectors may uniquely be associated with a distribution of scalar numerical values, such as random scalar numerical values (e.g., signal values and/or signal sample values), for example. Thus, it is understood, of course, that a distribution of scalar numerical values, for example, without loss of generality, substantially in accordance with the foregoing description and/or later description, is related to physical measurements, and is likewise understood to exist as physical signals and/or physical signal samples.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between and/or among the one or more server devices and/or one or more client devices, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, Md., 21050-2747), but may include other aspects, such as the Hadoop distributed file system (HDFS) (available from the Apache Software Foundation, 1901 Munsey Drive, Forrest Hill, Md., 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g., signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc., and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an imaging sensor, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc., that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between and/or among devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. The lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, 4G, or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between and/or among devices, between and/or among networks, within a network, and/or the like, including the foregoing, of course.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
forming a set of training parameters applicable to detection of two or more entities between and/or among a distribution of digitally stored entities from a plurality of digitally stored observations;
modifying one or more training parameters of the set of training parameters to define a translation applicable to detection of real-world entities corresponding to the two or more entities between and/or among a distribution of digitally stored observations, the forming of the translation to be based, at least in part, on:
a first process of generating the two or more entities between and/or among the distribution of digitally stored observations; and
a second process of discriminating between and/or among the generated two or more entities based, at least in part, on the modified one or more training parameters.

2. The method of claim 1, wherein the first process and the second process form a generative adversarial network (GAN) process.

3. The method of claim 2, further comprising iteratively repeating the first process and the second process to form a cycle-GAN process.

4. The method of claim 1, wherein the two or more entities in the distribution of entities correspond to entities in a visual observation or entities in an audio observation.

5. The method of claim 1, wherein the second process of discriminating between and/or among the generated two or more entities results in a second distribution of detected real-world entities.

6. The method of claim 1, wherein the first and second processes operate without user input.

7. The method of claim 1, wherein one or more of the first and the second processes are performed utilizing a neural network.

8. The method of claim 1, further comprising sampling one or more real-world observations to obtain a representation of the distribution of the real-world entities in the one or more real-world observations.

9. The method of claim 1, wherein the translation is applicable to two or more real-world domains.

10. An apparatus, comprising:
a processor coupled to at least one memory device to:
form a set of training parameters applicable to detection of two or more entities between and/or among a distribution of digitally stored entities from a plurality of digitally stored observations;
modify one or more training parameters of the set of training parameters to define a translation applicable to detection of real-world entities corresponding to the two or more entities between and/or among a distribution of digitally stored observations, the forming of the translation to be based, at least in part, on:
a first process to generate the two or more entities in the distribution of digitally stored observations; and
a second process to discriminate between and/or among the generated two or more entities based, at least in part, on the modified one or more training parameters.

11. The apparatus of claim 10, wherein the processor coupled to the at least one memory device are to form a generative adversarial network (GAN) process.

12. The apparatus of claim 10, wherein the two or more entities in the distribution of entities correspond to entities in a visual observation or entities in an audio observation.

13. The apparatus of claim 10, wherein the second process to discriminate between and/or among of the generated two or more entities provides a second distribution of detected real-world entities.

14. The apparatus of claim 10, wherein one or more of the first and the second processes are to be performed at least in part by a neural network.

15. The apparatus of claim 10, wherein the processor coupled to the at least one memory device are additionally to sample one or more of the real-world entities to obtain a representation of the distribution of the real-world entities.

16. The apparatus of claim 10, wherein the translation is applicable to two or more real-world domains.

17. An article, comprising:
a non-transitory storage medium, having instructions stored thereon, which, when executed by a computer processor coupled to at least one memory, are operable to:
form a set of training parameters applicable to detection of two or more entities between and/or among a distribution of digitally stored entities from a plurality of digitally stored observations;
modify one or more training parameters of the set of training parameters to define a translation applicable to detection of real-world entities corresponding to the two or more entities between and/or among a distribution of digitally stored observations, the forming of the translation to be based, at least in part, on:
a first process to generate the two or more entities in the distribution of digitally stored observations; and
a second process to discriminate between and/or among the generated two or more entities based, at least in part, on the modified one or more training parameters.

18. The article of claim 17, wherein the stored instructions are to implement a generative adversarial (GAN) process.

19. The article of claim 17, wherein the two or more entities in the distribution of entities correspond to entities in a visual observation or entities in an audio observation.

20. The article of claim 19, wherein the translation is applicable to two or more real-world domains.
